(19) United States
(12) Patent Application Publication
(10) Pub. No.: US 2026/0011901 A1
(43) Pub. Date: Jan. 8, 2026

(54) TERMINATION CIRCUIT

(71) Applicant: Murata Manufacturing Co., Ltd., Nagaokakyo-shi (JP)

(72) Inventor: Tetsurou ASHIDA, Nagaokakyo-shi (JP)

(21) Appl. No.: 19/328,306

(22) Filed: Sep. 15, 2025

Related U.S. Application Data
(63) Continuation of application No. PCT/JP2023/045424, filed on Dec. 19, 2023.

(30) Foreign Application Priority Data
Mar. 29, 2023 (JP) 2023-054379

(51) Int. Cl. H01P 1/24

(52) U.S. Cl. CPC H01P 1/24

(57) ABSTRACT

A termination circuit includes a first open stub that includes multiple first straight portions and multiple first connection portions with which the adjacent first straight portions are connected and that is formed in a meander pattern, and a second open stub that includes multiple second straight portions and multiple second connection portions with which the adjacent second straight portions are connected and that is formed in a meander pattern. The first open stub and the second open stub are provided on different layers and are electrically connected to each other. The first open stub is provided so as to be overlapped with at least part of the second open stub in a plan view and an extending direction of the first straight portions is different from an extending direction of the second straight portions.

### CROSS REFERENCE TO RELATED APPLICATION

This is a continuation of International Application No. PCT/JP2023/045424 filed on Dec. 19, 2023 which claims priority from Japanese Patent Application No. 2023-054379 filed on Mar. 29, 2023. The contents of these applications are incorporated herein by reference in their entireties.

### BACKGROUND OF THE DISCLOSURE

### Field of the Disclosure

The present disclosure relates to a termination circuit.

### Description of the Related Art

Japanese Unexamined Patent Application Publication No. 2009-21747, Japanese Unexamined Patent Application Publication No. 2017-216589, Japanese Unexamined Patent Application Publication No. 2011-66839, and International Publication No. 2021/117142 describe termination circuits (a band pass filter, a filter, a microwave harmonic processing circuit, and a harmonic matching circuit, respectively) that are each used in a radio-frequency circuit and that each include multiple open stubs. For example, the band pass filter in Japanese Unexamined Patent Application Publication No. 2009-21747 includes a grounded coplanar line and multiple open stubs connected to the grounded coplanar line. Differentiating the lengths of the multiple open stubs causes the band pass filter to function as an impedance matching circuit for an external load.

### BRIEF SUMMARY OF THE DISCLOSURE

In the configuration including the multiple open stubs, the area of the termination circuit in a plan view may be increased to make downsizing difficult. When the multiple open stubs are arranged so as to come close to each other, unintended coupling (electromagnetic coupling or capacitive coupling) may occur in each open stub to cause a shift from desired characteristics.

It is a possible benefit of the present disclosure to provide a termination circuit capable of achieving reduction in size and suppressing reduction in characteristics.

A termination circuit according to an aspect includes a first open stub that includes multiple first straight portions and multiple first connection portions with which the adjacent first straight portions are connected and that is formed in a meander pattern, and a second open stub that includes multiple second straight portions and multiple second connection portions with which the adjacent second straight portions are connected and that is formed in a meander pattern. The first open stub and the second open stub are provided on different layers and are electrically connected to each other. The first open stub is provided so as to be overlapped with at least part of the second open stub in a plan view and an extending direction of the first straight portions is different from an extending direction of the second straight portions.

According to the termination circuit of the present disclosure, it is possible to achieve reduction in size and to suppress reduction in characteristics.

### BRIEF DESCRIPTION OF THE SEVERAL VIEWS OF THE DRAWINGS

FIG. 1 is a plan view illustrating a termination circuit of an embodiment.

FIG. 2 is a plan view illustrating a second open stub in the termination circuit of the embodiment.

FIG. 3 is a cross-sectional view taken along a III-III′ line in FIG. 1.

FIG. 4 is a graph schematically indicating bandpass characteristics of a termination circuit of an example.

FIG. 5 is a plan view illustrating a first open stub in a termination circuit of a first comparative example.

FIG. 6 is a plan view illustrating a second open stub in the termination circuit of the first comparative example.

FIG. 7 is a graph schematically indicating the bandpass characteristics of the termination circuit of the first comparative example.

FIG. 8 is a plan view illustrating a first open stub in a termination circuit of a second comparative example.

FIG. 9 is a plan view illustrating a second open stub in the termination circuit of the second comparative example.

FIG. 10 is a graph schematically indicating the bandpass characteristics of the termination circuit of the second comparative example.

FIG. 11 is a plan view illustrating a first open stub in a termination circuit of a third comparative example.

FIG. 12 is a plan view illustrating a first open stub in the termination circuit of the third comparative example.

FIG. 13 is a graph schematically indicating the bandpass characteristics of the termination circuit of the third comparative example.

FIG. 14 is a plan view illustrating a termination circuit of a modification.

### DETAILED DESCRIPTION OF THE DISCLOSURE

Embodiments of the present disclosure will herein be described in detail with reference to the drawings. The embodiments are not intended to restrict the present disclosure. The respective embodiments are only examples and partial replacement or combination of components described in different embodiments is available.

### EMBODIMENT

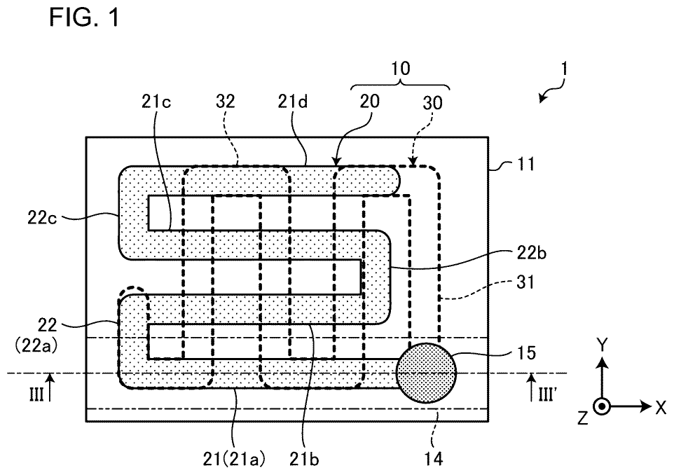

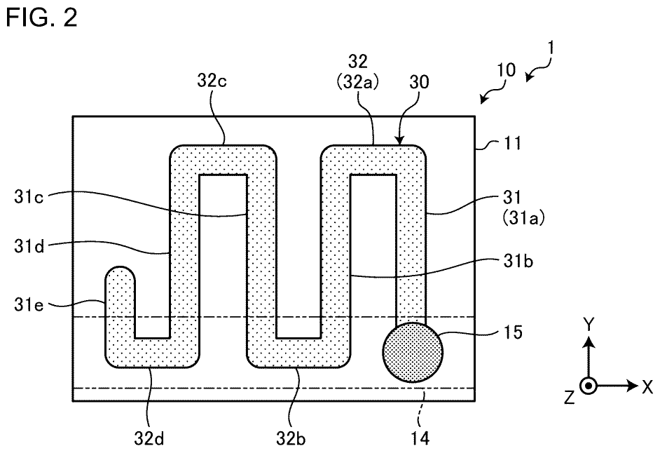

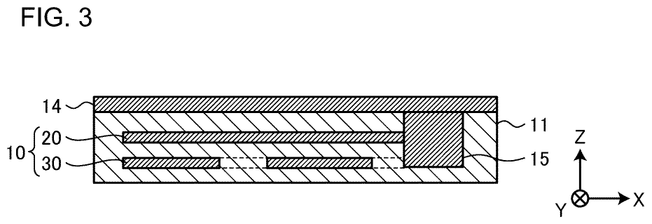

FIG. 1 is a plan view illustrating a termination circuit of an embodiment. FIG. 2 is a plan view illustrating a second open stub in the termination circuit of the embodiment. FIG. 3 is a cross-sectional view taken along a III-III′ line in FIG. 1. A main line 14 is indicated by alternate long and two short dashes lines and a second open stub 30 is indicated by a dotted line in FIG. 1 for improvement of visibility.

A termination circuit 1 of the present embodiment is used for, for example, a transmission circuit of a radio-frequency (RF) module. More specifically, the termination circuit 1 functions as a filter that is connected to an amplifier circuit in the transmission circuit and that transmits signals in a certain frequency band, among signals outputted from the amplifier circuit.

As illustrated in FIG. 1 to FIG. 3, the termination circuit 1 according to a first embodiment includes a substrate 11, the main line 14, a via 15, and an open stub 10 (a first open stub 20 and the second open stub 30).

The substrate 11 is a multilayer substrate in which multiple dielectric layers are laminated. The substrate 11 is, for example, a printed circuit board made of glass epoxy or the like, a ceramic substrate such as an alumina substrate, a flexible substrate made of polyimide or the like, or a liquid crystal polymer substrate.

As illustrated in FIG. 3, the main line 14 is provided on a main surface of the substrate 11. One end of the main line 14 is connected to, for example, the amplifier circuit (not illustrated) in the transmission circuit and the other end of the main line 14 is connected to, for example, an antenna.

The open stub 10 is provided on inner layers of the substrate 11. The open stub 10 includes the first open stub 20 and the second open stub 30. The first open stub 20 and the second open stub 30 are provided on different layers and are electrically connected to each other. The second open stub 30, the first open stub 20, and the main line 14 are sequentially laminated in a direction vertical to the main surface of the substrate 11. The second open stub 30 is provided on a layer more apart from the main line 14 (the main surface of the substrate 11) than the layer of the first open stub 20. The first open stub 20 is provided on a layer between the main line 14 and the second open stub 30. Any of the first open stub 20 and the second open stub 30 may be provided on the main surface of the substrate 11 on which the main line 14 is formed.

In the following description, the thickness direction of the substrate 11 may be referred to as the Z direction, a direction which is parallel to the main surface of the substrate 11 and in which first straight portions 21 extend may be referred to as the X direction, and a direction orthogonal to the X direction is referred to as the Y direction. In the following description, a plan view indicates the arrangement relationship when viewed from a direction vertical to the main surface of the substrate 11.

As illustrated in FIG. 3, one end of the first open stub 20 is connected to the main line 14 via the via 15. The other end of the first open stub 20 is opened. One end of the second open stub 30 is connected to the main line 14 via the via 15. The other end of the second open stub 30 is opened. In other words, the first open stub 20 and the second open stub 30 are electrically connected to the main line 14 via the common via 15. The via 15 is arranged so as to be overlapped with the main line 14 in a plan view, as illustrated in FIG. 1 and FIG. 2. However, the via 15 may be arranged at a position that is not overlapped with the main line 14 in a plan view.

As illustrated in FIG. 1, the first open stub 20 includes the multiple first straight portions 21 and multiple first connection portions 22 with which the adjacent first straight portions 21 are connected and is formed in a meander pattern. The multiple first straight portions 21 extend in the X direction and are arrayed at intervals in the Y direction. The multiple first connection portions 22 extend in the Y direction. The end portions of the two first straight portions 21 adjacent in the Y direction are connected to each other with the corresponding first connection portion 22.

First straight portions 21a, 21b, 21c, and 21d in the multiple first straight portions 21 are sequentially arrayed in the Y direction from a position close to the via 15. The multiple first connection portions 22 include first connection portions 22a, 22b, and 22c. The first straight portion 21a, the first connection portion 22a, the first straight portion 21b, the first connection portion 22b, the first straight portion 21c, the first connection portion 22c, and the first straight portion 21d are sequentially connected in the meander pattern from the via 15.

Particularly, among the multiple first straight portions 21, one end (the right end in FIG. 1) of the first straight portion 21a, which is positioned in an outer-side portion in the array direction (the Y direction), is connected to the via 15. The other ends (the left ends in FIG. 1) of the first straight portions 21a and 21b, which are adjacent to each other in the Y direction, are connected with the first connection portion 22a. One ends (the right ends) of the first straight portions 21b and 21c, which are adjacent to each other in the Y direction, are connected with the first connection portion 22b. The other ends (the left ends) of the first straight portions 21c and 21d, which are adjacent to each other in the Y direction, are connected with the first connection portion 22c. Among the multiple first straight portions 21, one end (the right end) of the first straight portion 21d, which is positioned in an outer-side portion in the array direction and at a side opposite to the side of the first straight portion 21a, is opened.

As illustrated in FIG. 2, the second open stub 30 includes multiple second straight portions 31 and multiple second connection portions 32 with which the adjacent second straight portions 31 are connected and is formed in a meander pattern. The multiple second straight portions 31 extend in the Y direction and are arrayed at intervals in the X direction. The multiple second connection portions 32 extend in the X direction. The end portions of the two second straight portions 31 adjacent in the X direction are connected to each other with the corresponding second connection portion 32.

Particularly, second straight portions 31a, 31b, 31c, 31d, and 31e in the multiple second straight portions 31 are sequentially arrayed in the X direction from a position close to the via 15. The multiple second connection portions 32 include second connection portions 32a, 32b, 32c, and 32d. The second straight portion 31a, the second connection portion 32a, the second straight portion 31b, the second connection portion 32b, the second straight portion 31c, the second connection portion 32c, the second straight portion 31d, the second connection portion 32d, and the second straight portion 31e are sequentially connected in the meander pattern from the via 15.

Particularly, among the multiple second straight portions 31, one end (the lower end in FIG. 2) of the second straight portion 31a, which is positioned in an outer-side portion in the array direction (the X direction), is connected to the via 15. The other ends (the upper ends in FIG. 2) of the second straight portions 31a and 31b, which are adjacent to each other in the X direction, are connected with the second connection portion 32a. One ends (the lower ends) of the second straight portions 31b and 31c, which are adjacent to each other in the X direction, are connected with the second connection portion 32b. The other ends (the upper ends) of the second straight portions 31c and 31d, which are adjacent to each other in the X direction, are connected with the second connection portion 32c. The other ends (the lower ends) of the second straight portions 31d and 31e, which are adjacent to each other in the X direction, are connected with the second connection portion 32d. Among the multiple second straight portions 31, the other end (the upper end) of the second straight portion 31e, which is positioned in an outer-side portion in the array direction and at a side opposite to the side of the second straight portion 31a, is opened.

As illustrated in FIG. 1 and FIG. 2, the first open stub 20 is provided so as to be overlapped with at least part of the second open stub 30 in a plan view. The extending direction of the first straight portions 21 is different from the extending direction of the second straight portions 31.

More specifically, among the multiple first straight portions 21 of the first open stub 20, the first straight portion 21a positioned in an outer-side portion in the array direction is overlapped with the second connection portions 32b and 32d of the second open stub 30. Among the multiple first straight portions 21 of the first open stub 20, the first straight portion 21d, which is positioned in an outer-side portion in the array direction and at a side opposite to the side of the first straight portion 21a, is overlapped with part of the second connection portion 32a and the second connection portion 32c of the second open stub 30.

Among the multiple first straight portions 21 of the first open stub 20, the first straight portions 21b and 21c, which are positioned in a central portion in the array direction (the Y direction), intersect with the second straight portions 31b, 31c, and 31d, which are positioned in a central portion in the array direction (the X direction), among the multiple second straight portions 31 of the second open stub 30.

Among the multiple second straight portions 31 of the second open stub 30, the second straight portion 31a, which is positioned in an outer-side portion in the array direction, is provided at a position that is not overlapped with the first open stub 20. Among the multiple second straight portions 31 of the second open stub 30, the second straight portion 31e, which is positioned in an outer-side portion in the array direction and at a side opposite to the side of the second straight portion 31a, is overlapped with the first connection portion 22a of the first open stub 20. The second straight portion 31a may be provided at a position that is overlapped with the first open stub 20.

In such a configuration, since the first open stub 20 and the second open stub 30 are provided on different layers and are at least partially overlapped with each other in a plan view, the termination circuit 1 is capable of reducing the size, compared with a configuration in which the first open stub 20 and the second open stub 30 are provided on the same face.

Since the extending direction of the first straight portions 21 of the first open stub 20 intersects with the extending direction of the second straight portions 31 of the second open stub 30, the area of the portions in which the first straight portions 21 are overlapped with the second straight portions 31 is decreased in a plan view, compared with a configuration in which the first straight portions 21 are overlapped with the second straight portions 31 and the first straight portions 21 and the second straight portions 31 are provided so as to extend in the same direction. Accordingly, it is possible to suppress unintended coupling (electromagnetic coupling or capacitive coupling) between the first open stub 20 and the second open stub 30. Consequently, the termination circuit 1 is capable of achieving bandpass characteristics having small amounts of shift from the bandpass characteristics of the single first open stub 20 and the bandpass characteristics of the single second open stub 30.

The length in the extending direction (the X direction) of the multiple first straight portions 21 of the first open stub 20 is different from the length in the extending direction (the Y direction) of the multiple second straight portions 31 of the second open stub 30. In the termination circuit 1 of the embodiment, the length in the extending direction (the X direction) of the multiple first straight portions 21 is longer than the length in the extending direction (the Y direction) of the multiple second straight portions 31. With such a configuration, even when the electrical length of the first open stub 20 is different from the electrical length of the second open stub 30 as described below, it is easy to arrange the outermost first connection portion 22, among the multiple first connection portions 22 of the first open stub 20, so as to be overlapped with the outermost second straight portion 31, among the multiple second straight portions 31 of the second open stub 30. Accordingly, it is easy to decrease the areas occupied by the first open stub 20 and the second open stub 30 on the substrate 11 in a plan view of the substrate 11.

The number of the multiple first straight portions 21 of the first open stub 20 is different from the number of the multiple second straight portions 31 of the second open stub 30. In the present embodiment, the number of the multiple first straight portions 21 of the first open stub 20 is four while the number of the multiple second straight portions 31 of the second open stub 30 is five. In other words, the number (the number of folds) of the multiple first connection portions 22 of the first open stub 20 is different from the number (the number of folds) of the multiple second connection portions 32 of the second open stub 30. In the present embodiment, the number of the multiple first connection portions 22 of the first open stub 20 is three while the number of the multiple second connection portions 32 of the second open stub 30 is four. With such a configuration, even when the electrical length of the first open stub 20 is different from the electrical length of the second open stub 30 as described below, it is easy to arrange the outermost first connection portion 22, among the multiple first connection portions 22 of the first open stub 20, so as to be overlapped with the outermost second straight portion 31, among the multiple second straight portions 31 of the second open stub 30. Accordingly, it is easy to decrease the areas occupied by the first open stub 20 and the second open stub 30 on the substrate 11 in a plan view of the substrate 11.

In the present embodiment, the electrical length of the first open stub 20 is different from the electrical length of the second open stub 30. Accordingly, each of the first open stub 20 and the second open stub 30 has characteristics in which signals in different frequency bands are transmitted (or attenuated). When the first open stub 20 and the second open stub 30 are made of the same material and are provided in the same substrate 11, the ratio between the electrical lengths of the first open stub 20 and the second open stub 30 is substantially equal to the ratio between the total length along the extending directions of the multiple first straight portions 21 and the multiple first connection portions 22 and the total length along the extending directions of the multiple second straight portions 31 and the multiple second connection portions 32.

As described above, the first open stub 20 and the second open stub 30 are capable of improving the degree of freedom of the respective lengths, numbers, and so on of the first straight portions 21 and the second straight portions 31 to realize the respective desired characteristics.

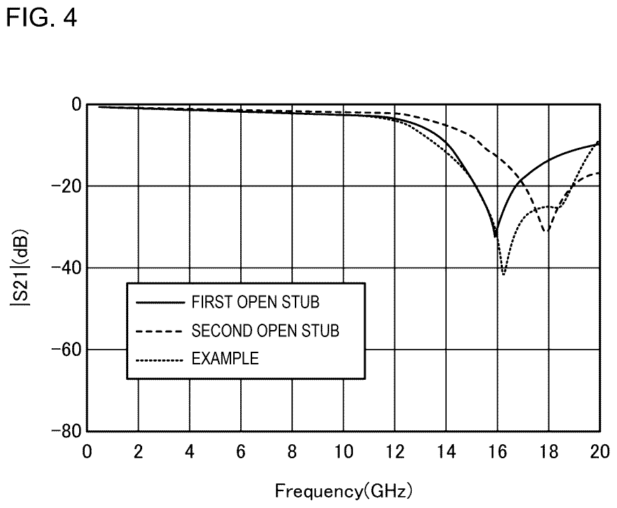

FIG. 4 is a graph schematically indicating the bandpass characteristics of a termination circuit of an example. In the graph illustrated in FIG. 4, the vertical axis represents bandpass characteristic |S21| and the horizontal axis represents frequency. The graph illustrated in FIG. 4 indicates the simulation result of the bandpass characteristic of the termination circuit 1 including the first open stub 20 and the second open stub 30. The simulation results of the bandpass characteristic of the single first open stub 20 and the bandpass characteristic of the single second open stub 30 are also indicated in FIG. 4.

As illustrated in FIG. 4, the single first open stub 20 exhibits the minimum value of the bandpass characteristic |S21| (the maximum value of the attenuation of the signal) at a frequency near 16 GHz. The single second open stub 30 exhibits the minimum value of the bandpass characteristic |S21| (the maximum value of the attenuation of the signal) at a frequency near 18 GHz. The termination circuit 1 according to the example exhibits the minimum value of the bandpass characteristic |S21| at a frequency between the frequency (16 GHz) indicating the minimum value of the bandpass characteristic |S21| of the first open stub 20 and the frequency (18 GHz) indicating the minimum value of the bandpass characteristic |S21| of the second open stub 30.

In addition, the termination circuit 1 according to the example has the bandpass characteristic |S21| similar to that of the single first open stub 20 in a frequency range higher than or equal to 0 GHz and lower than or equal to 16 GHz and exhibits the bandpass characteristic |S21| lower than that of the single first open stub 20 (high attenuation) in a frequency range higher than or equal to 16 GHz and lower than or equal to 20 GHz. The termination circuit 1 according to the example exhibits the bandpass characteristic |S21| lower than that of the single second open stub 30 in a frequency range higher than or equal to 0 GHz and lower than or equal to 17 GHZ and exhibits the bandpass characteristic |S21| similar to or slightly higher than that of the single second open stub 30 in a frequency range higher than or equal to 16 GHz and lower than or equal to 20 GHZ.

As described above, in the termination circuit 1 according to the example, the first open stub 20 and the second open stub 30 are arranged so as to be overlapped with each other and the extending direction of the first straight portions 21 is provided so as to intersect with the extending direction of the second straight portions 31. Accordingly, the termination circuit 1 according to the example has small shifts of the frequency indicating the minimum value of the bandpass characteristic |S21| and the magnitude of the bandpass characteristic |S21| (the attenuation) with respect to the bandpass characteristic of the single first open stub 20 and the bandpass characteristic of the single second open stub 30.

### First Comparative Example

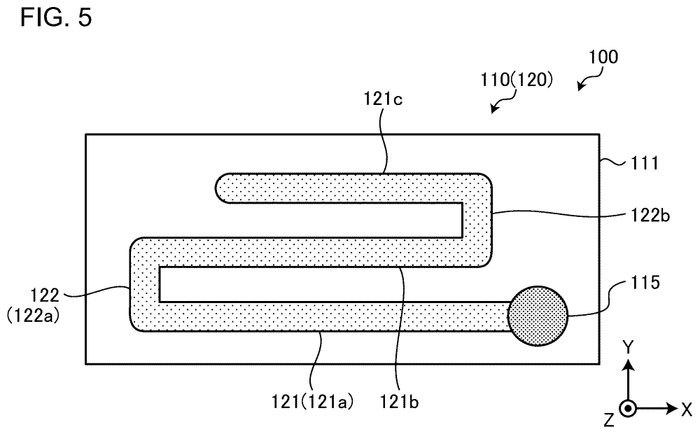

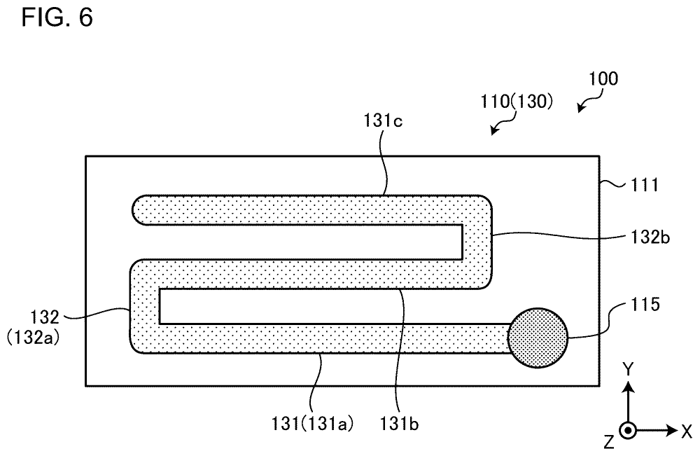

FIG. 5 is a plan view illustrating a first open stub in a termination circuit of a first comparative example. FIG. 6 is a plan view illustrating a second open stub in the termination circuit of the first comparative example. As illustrated in FIG. 5 and FIG. 6, a termination circuit 100 of the first comparative example includes a substrate 111, a via 115, and an open stub 110 (a first open stub 120 and a second open stub 130). The main line is omitted in FIG. 5 and FIG. 6.

As illustrated in FIG. 5, the first open stub 120 includes multiple first straight portions 121 and multiple first connection portions 122 with which the adjacent first straight portions 121 are connected and is formed in a meander pattern. The multiple first straight portions 121 extend in the X direction and are arrayed at intervals in the Y direction. The multiple first connection portions 122 extend in the Y direction. The end portions of the two first straight portions 121 adjacent in the Y direction are connected to each other with the corresponding first connection portion 122. A first straight portion 121a, a first connection portion 122a, a first straight portion 121b, a first connection portion 122b, and a first straight portion 121c are sequentially connected in the meander pattern from the via 115. Among the multiple first straight portions 121, one end (the left end in FIG. 5) of the first straight portion 121c at a position apart from the via 115 is opened.

As illustrated in FIG. 6, the second open stub 130 includes multiple second straight portions 131 and multiple second connection portions 132 with which the adjacent second straight portions 131 are connected and is formed in a meander pattern. The multiple second straight portions 131 extend in the X direction and are arrayed at intervals in the Y direction. The multiple second connection portions 132 extend in the Y direction. The end portions of the two second straight portions 131 adjacent in the Y direction are connected to each other with the corresponding second connection portion 132. A second straight portion 131a, a second connection portion 132a, a second straight portion 131b, a second connection portion 132b, and a second straight portion 131c are sequentially connected in the meander pattern from the via 115. Among the multiple second straight portions 131, one end (the left end in FIG. 6) of the second straight portion 131c at a position apart from the via 115 is opened.

As illustrated in FIG. 5 and FIG. 6, in the termination circuit 100 according to the first comparative example, the first open stub 120 and the second open stub 130 are arranged so as to be overlapped with each other and the extending direction of the first straight portions 121 is the same as the extending direction of the second straight portions 131.

The first straight portions 121a, 121b, and 121c of the first open stub 120 are provided so as to be overlapped with the second straight portions 131a, 131b, and 131c of the second open stub 130, respectively. The extending direction of the multiple first straight portions 121 is the same as the extending direction of the multiple second straight portions 131. The length of the first straight portion 121c of the first open stub 120 is shorter than the length of the second straight portion 131c of the second open stub 130. The multiple first connection portions 122a and 122b of the first open stub 120 are provided so as to be overlapped with the multiple second connection portions 132a and 132b of the second open stub 130. The extending direction of the multiple first connection portions 122 is the same as the extending direction of the multiple second connection portions 132.

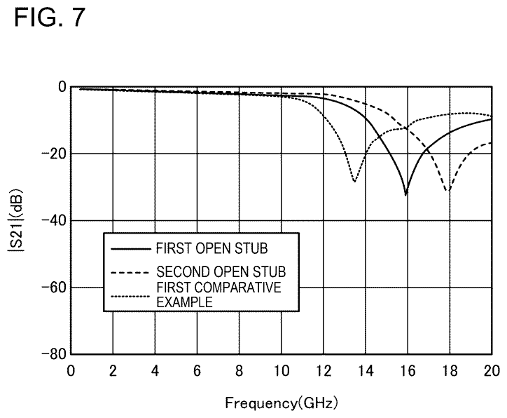

FIG. 7 is a graph schematically indicating the bandpass characteristics of the termination circuit of the first comparative example. The graph illustrated in FIG. 7 indicates the simulation result of the bandpass characteristic of the termination circuit 100 of the first comparative example including the first open stub 120 and the second open stub 130. The simulation results of the bandpass characteristic of the single first open stub 120 and the bandpass characteristic of the single second open stub 130 are also indicated in FIG. 7.

As illustrated in FIG. 7, the single first open stub 120 exhibits the minimum value of the bandpass characteristic |S21| (the maximum value of the attenuation of the signal) at a frequency near 16 GHZ. The single second open stub 130 exhibits the minimum value of the bandpass characteristic |S21| (the maximum value of the attenuation of the signal) at a frequency near 18 GHZ. The termination circuit 100 according to the first comparative example exhibits the minimum value of the bandpass characteristic |S21| in a frequency range higher than or equal to 13 GHZ and lower than or equal to 14 GHZ. In other words, in the termination circuit 100 according to the first comparative example, the frequency indicating the minimum value of the bandpass characteristic |S21| is shifted from the frequency (16 GHz) indicating the minimum value of the bandpass characteristic |S21| of the first open stub 120 and the frequency (18 GHz) indicating the minimum value of the bandpass characteristic |S21| of the second open stub 130.

In addition, the termination circuit 100 according to the first comparative example has the bandpass characteristic |S21| lower than that of the single first open stub 120 in a frequency range higher than or equal to 0 GHz and lower than or equal to 14.5 GHZ and exhibits the bandpass characteristic |S21| higher than that of the single first open stub 120 in a frequency range higher than or equal to 14.5 GHZ and lower than or equal to 20 GHz. The termination circuit 100 according to the first comparative example exhibits the bandpass characteristic |S21| lower than that of the single second open stub 130 in a frequency range higher than or equal to 0 GHz and lower than or equal to 16 GHz and exhibits the bandpass characteristic |S21| higher than that of the second open stub 130 in a frequency range higher than or equal to 16 GHZ and lower than or equal to 20 GHZ.

As described above, the bandpass characteristic of the termination circuit 100 according to the first comparative example is greatly shifted from the bandpass characteristic of the single first open stub 120 and the bandpass characteristic of the single second open stub 130, compared with the termination circuit 1 according to the example.

### Second Comparative Example

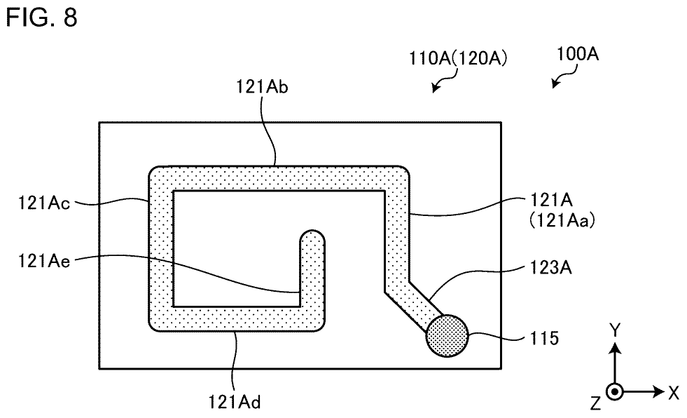

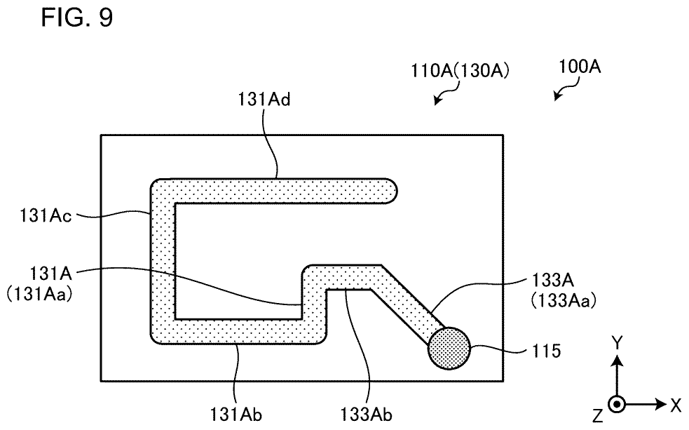

FIG. 8 is a plan view illustrating a first open stub in a termination circuit of a second comparative example. FIG. 9 is a plan view illustrating a second open stub in the termination circuit of the second comparative example. As illustrated in FIG. 8 and FIG. 9, a termination circuit 100A of the second comparative example differs from the embodiment and the first comparative example described above in a configuration in which an open stub 110A (a first open stub 120A and a second open stub 130A) is formed in spiral patterns. The main line is omitted in FIG. 8 and FIG. 9.

As illustrated in FIG. 8, the first open stub 120A includes multiple first straight portions 121A connected in a spiral pattern and a connection portion 123A with which the multiple first straight portions 121A are connected to the via 115. The multiple first straight portions 121A include first straight portions 121Aa, 121Ac, and 121Ae extending in the Y direction and first straight portions 121Ab and 121Ad extending in the X direction. The connection portion 123A and the first straight portions 121Aa, 121Ab, 121Ac, 121Ad, and 121Ae are sequentially connected in the spiral pattern from the via 115. One end of the first straight portion 121Ae is opened.

As illustrated in FIG. 9, the second open stub 130A includes multiple second straight portions 131A connected in a spiral pattern and a connection portion 133A (133Aa and 133Ab) with which the multiple second straight portions 131A are connected to the via 115. The multiple second straight portions 131A include second straight portions 131Aa and 131Ac extending in the Y direction and second straight portions 131Ab and 131Ad extending in the X direction. The connection portion 133A (133Aa and 133Ab) and the second straight portions 131Aa, 131Ab, 131Ac, and 131Ad are sequentially connected in the spiral pattern from the via 115. One end of the second straight portion 131Ad is opened.

As illustrated in FIG. 8 and FIG. 9, the first open stub 120A and the second open stub 130A are connected in the opposite directions in the spiral patterns from the via 115 in a plan view. In the termination circuit 100A according to the second comparative example, the spiral-shaped first open stub 120A and the spiral-shaped second open stub 130A are arranged so as to be overlapped with each other and the extending direction of the multiple first straight portions 121A is the same as the extending direction of the multiple second straight portions 131A. In other words, the first straight portions 121Ab, 121Ac, 121Ad, and 121Ae of the first open stub 120A are arranged so as to be overlapped with and extend in the same direction as the second straight portions 131Ad, 131Ac, 131Ab, and 131Aa of the second open stub 130A, respectively.

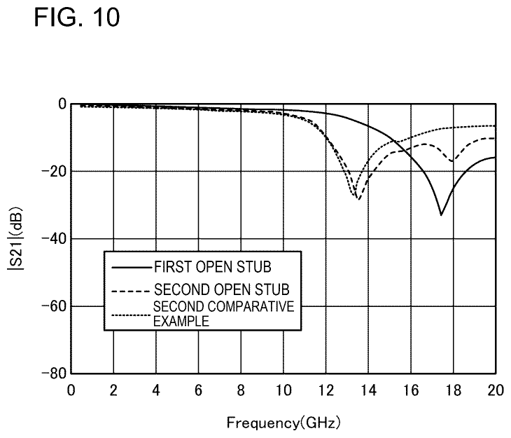

FIG. 10 is a graph schematically indicating the bandpass characteristics of the termination circuit of the second comparative example. The graph illustrated in FIG. 10 indicates the simulation result of the bandpass characteristic of the termination circuit 100A of the second comparative example including the first open stub 120A and the second open stub 130A. The simulation results of the bandpass characteristic of the single first open stub 120A and the bandpass characteristic of the single second open stub 130A are also indicated in FIG. 10.

As illustrated in FIG. 10, the single first open stub 120A exhibits the minimum value of the bandpass characteristic |S21| (the maximum value of the attenuation of the signal) in a frequency range higher than or equal to 17 GHz and lower than or equal to 18 GHz. The single second open stub 130A exhibits the minimum value of the bandpass characteristic |S21| (the maximum value of the attenuation of the signal) in a frequency range higher than or equal to 13 GHz and lower than or equal to 14 GHz. The termination circuit 100A according to the second comparative example exhibits the minimum value of the bandpass characteristic |S21| in a frequency range higher than or equal to 13 GHZ and lower than or equal to 14 GHz.

In the termination circuit 100A according to the second comparative example, the frequency indicating the minimum value of the bandpass characteristic |S21| is substantially equal to the frequency indicating the minimum value of the bandpass characteristic |S21| of the single second open stub 130A. The termination circuit 100A according to the second comparative example has the frequency characteristic of the bandpass characteristic |S21| similar to that of the single second open stub 130A. However, the frequency characteristic of the bandpass characteristic |S21| of the termination circuit 100A according to the second comparative example greatly differs from the frequency characteristic of the bandpass characteristic |S21| of the single first open stub 120A.

Accordingly, the bandpass characteristic of the termination circuit 100A according to the second comparative example is greatly shifted from at least the bandpass characteristic of the single first open stub 120A, compared with the termination circuit 1 according to the example.

### Third Comparative Example

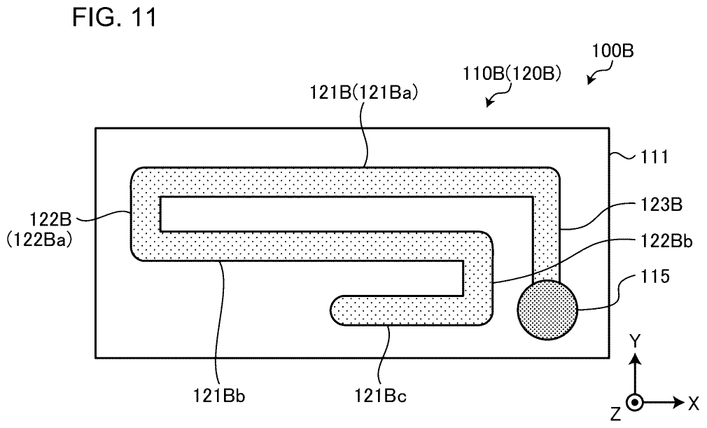

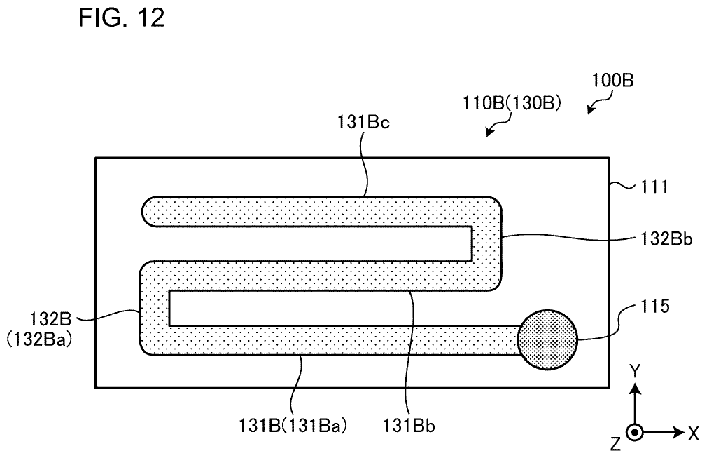

FIG. 11 is a plan view illustrating a first open stub in a termination circuit of a third comparative example. FIG. 12 is a plan view illustrating a first open stub in the termination circuit of the third comparative example. As illustrated in FIG. 11 and FIG. 12, a termination circuit 100B of the third comparative example differs from the termination circuit 100 of the first comparative example described above in the order of connection between multiple first straight portions 121B of a first open stub 120B and the via 115.

As illustrated in FIG. 11, the first open stub 120B includes the multiple first straight portions 121B, multiple first connection portions 122B, and a connection portion 123B. In the multiple first straight portions 121B, first straight portions 121Ba, 121Bb, and 121Bc are sequentially arrayed in the Y direction from a position apart from the via 115. The connection portion 123B, the first straight portion 121Ba, a first connection portion 122Ba, the first straight portion 121Bb, a first connection portion 122Bb, and the first straight portion 121Bc are sequentially connected in the meander pattern from the via 115. One end of the first straight portion 121Bc is opened.

As illustrated in FIG. 12, a second open stub 130B includes multiple second straight portions 131B and multiple second connection portions 132B. In the multiple second straight portions 131B, second straight portions 131Ba, 131Bb, and 131Bc are sequentially arrayed in the Y direction from a position close to the via 115. The second straight portion 131Ba, a second connection portion 132Ba, the second straight portion 131Bb, a second connection portion 132Bb, and the second straight portion 131Bc are sequentially connected in the meander pattern from the via 115. One end of the second straight portion 131Bc is opened.

As illustrated in FIG. 11 and FIG. 12, in the termination circuit 100B according to the third comparative example, the first open stub 120B and the second open stub 130B are arranged so as to be overlapped with each other and the extending direction of the first straight portions 121B is the same as the extending direction of the second straight portions 131B.

The multiple first straight portions 121Ba, 121Bb, and 121Bc of the first open stub 120B are provided so as to be overlapped with the multiple second straight portions 131Bc, 131Bb, and 131Ba of the second open stub 130B, respectively. The extending direction of the multiple first straight portions 121B is the same as the extending direction of the multiple second straight portions 131B. The length of the first straight portion 121Bc of the first open stub 120B is shorter than the length of the second straight portion 131Bc of the second open stub 130B. The multiple first connection portions 122Ba and 122Bb of the first open stub 120B are provided at positions that are not overlapped with the multiple second connection portions 132Ba and 132Bb of the second open stub 130B, respectively, in the third comparative example.

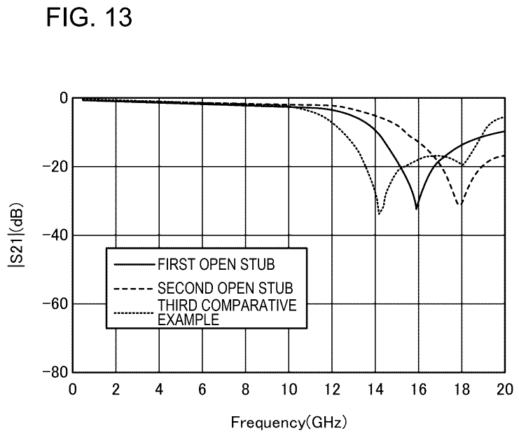

FIG. 13 is a graph schematically indicating the bandpass characteristics of the termination circuit of the third comparative example. The graph illustrated in FIG. 13 indicates the simulation result of the bandpass characteristic of the termination circuit 100B of the third comparative example including the first open stub 120B and the second open stub 130B. The simulation results of the bandpass characteristic of the single first open stub 120B and the bandpass characteristic of the single second open stub 130B are also indicated in FIG. 13.

As illustrated in FIG. 13, the single first open stub 120B exhibits the minimum value of the bandpass characteristic |S21| (the maximum value of the attenuation of the signal) at a frequency close to 16 GHz. The single second open stub 130B exhibits the minimum value of the bandpass characteristic |S21| (the maximum value of the attenuation of the signal) at a frequency close to 18 GHz. The termination circuit 100B according to the third comparative example exhibits the minimum value of the bandpass characteristic |S21| at a frequency close to 14 GHz. In other words, in the termination circuit 100B according to the third comparative example, the frequency indicating the minimum value of the bandpass characteristic |S21| is shifted from the frequency (16 GHZ) indicating the minimum value of the bandpass characteristic |S21| of the first open stub 120B and the frequency (18 GHZ) indicating the minimum value of the bandpass characteristic |S21| of the second open stub 130B.

In addition, the termination circuit 100B according to the third comparative example has the bandpass characteristic |S21| lower than that of the single first open stub 120B in a frequency range higher than or equal to 0 GHz and lower than or equal to 15 GHZ and exhibits the bandpass characteristic |S21| higher than that of the single first open stub 120 in a frequency range higher than or equal to 15 GHz and lower than or equal to 20 GHZ. The termination circuit 100B according to the third comparative example has the bandpass characteristic |S21| lower than that of the single second open stub 130B in a frequency range higher than or equal to 0 GHz and lower than or equal to 17 GHz and exhibits the bandpass characteristic |S21| higher than that of the single second open stub 130B in a frequency range higher than or equal to 17 GHz and lower than or equal to 20 GHZ.

As described above, the bandpass characteristic of the termination circuit 100B according to the third comparative example is greatly shifted from the bandpass characteristic of the single first open stub 120B and the bandpass characteristic of the single second open stub 130B, compared with the termination circuit 1 according to the example.

### Modification

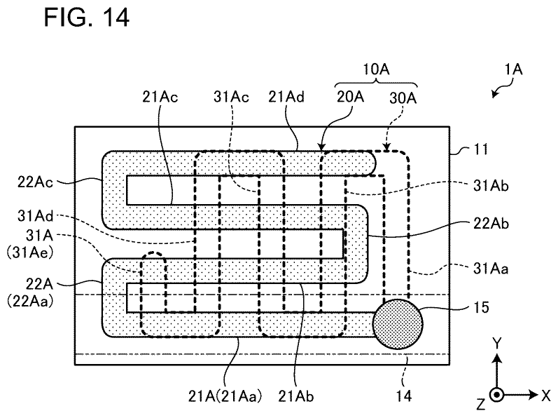

FIG. 14 is a plan view illustrating a termination circuit of a modification. As illustrated in FIG. 14, a termination circuit 1A according to the modification differs from the embodiment described above in that the length in the extending direction of first straight portions 21A of a first open stub 20A is longer than the length in the extending direction of the first straight portions 21 of the first open stub 20 in the embodiment (refer to FIG. 1).

First straight portions 21Ab and 21Ac positioned in a central portion in the array direction, among the multiple first straight portions 21A of the first open stub 20A, intersect with second straight portions 31Ab, 31Ac, and 31Ad positioned in a central portion in the array direction, among multiple second straight portions 31A of a second open stub 30A. The multiple first straight portions 21A extend in the array direction (the X direction) of the multiple second straight portions 31A of the second open stub 30A toward the outer-side portion with respect to a second straight portion 31Ae. The first straight portion 21Ab of the first open stub 20A intersects with the second straight portion 31Ae positioned in an outer-side portion in the array direction, among the multiple second straight portions 31A of the second open stub 30A.

Among the multiple second straight portions 31A of the second open stub 30A, the second straight portion 31Ae positioned in an outer-side portion in the array direction is provided at a position that is not overlapped with a first connection portion 22Aa of the first open stub 20A.

The configurations of the termination circuit 1 according to the embodiment described above and the termination circuit 1A according to the modification are only examples and may be appropriately changed. For example, the numbers, the lengths in the extending direction, the arrangement interval, and so on of the first straight portions 21 and 21A and the second straight portions 31 and 31A may be appropriately changed in accordance with the required bandpass characteristics. The first connection portions 22, first connection portions 22A, the second connection portions 32, and second connection portions 32A have linear shapes extending in a direction orthogonal to the respective straight portions. However, the first connection portions 22 and 22A and the second connection portions 32 and 32A are not limited to this and may have other shapes, such as curved shapes.

Although the example is described in which the termination circuits 1 and 1A are used in, for example, the transmission circuit in an RF module, the termination circuits 1 and 1A are not limited to this. The termination circuits 1 and 1A may be used in another radio-frequency module or radio-frequency circuit.

The embodiments described above are provided to facilitate the understanding of the present disclosure and is not intended to interpret the present disclosure in a limited manner. The present disclosure may be modified or changed without departing from the scope and sprit of the present disclosure and equivalents of the present disclosure are included in the present disclosure.

The present disclosure may have the following configuration.
(1) A termination circuit includes a first open stub that includes multiple first straight portions and multiple first connection portions with which the adjacent first straight portions are connected and that is formed in a meander pattern; and a second open stub that includes multiple second straight portions and multiple second connection portions with which the adjacent second straight portions are connected and that is formed in a meander pattern. The first open stub and the second open stub are provided on different layers and are electrically connected to each other. The first open stub is provided so as to be overlapped with at least part of the second open stub in a plan view and an extending direction of the first straight portions is different from an extending direction of the second straight portions.
(2) In the termination circuit described in (1), an electrical length of the first open stub is different from an electrical length of the second open stub.
(3) In the termination circuit described in (1) or (2), a length in the extending direction of the first straight portions is different from a length in the extending direction of the second straight portions.
(4) In the termination circuit described in any of (1) to (3), a number of the multiple first straight portions of the first open stub is different from a number of the multiple second straight portions of the second open stub.
(5) In the termination circuit described in any of (1) to (4), among the multiple first straight portions, the first straight portion positioned in an outermost portion in an array direction is overlapped with the second connection portions of the second open stub, and among the multiple first straight portions, the first straight portion positioned in a central portion in the array direction is orthogonal to the second straight portions of the second open stub.

1, 1A, 100, 100A, 100B termination circuit
10, 110, 110A open stub
11, 111 substrate
14 main line
15, 115 via
20, 20A, 120, 120A, 120B first open stub
21, 21a, 21b, 21c, 21d, 21A, 121, 121A, 121B first

straight portion

22, 22a, 22b, 22c, 22A, 122, 122B first connection

portion

30, 30A, 130, 130A, 130B second open stub
31, 31a, 31b, 31c, 31d, 31e, 31A, 131, 131A, 131B

second straight portion

32, 32a, 32b, 32c, 32d, 32A, 132, 132B second

connection portion

1. A termination circuit comprising:
a first open stub including a plurality of first straight portions and a plurality of first connection portions, adjacent first straight portions among the plurality of first straight portions being connected with respective ones of the plurality of first connection portions, and the first open stub being provided in a meander pattern; and
a second open stub including a plurality of second straight portions and a plurality of second connection portions, adjacent second straight portions among the plurality of second straight portions being connected with respective ones of the plurality of second connection portions, and the second open stub being provided in a meander pattern,
wherein the first open stub and the second open stub are provided on different layers and are electrically connected to each other, and
wherein the first open stub is provided so as to be overlapped with at least a part of the second open stub in a plan view and an extending direction of the first straight portions is different from an extending direction of the second straight portions.

2. The termination circuit according to claim 1,
wherein an electrical length of the first open stub is different from an electrical length of the second open stub.

3. The termination circuit according to claim 1,
wherein a length in the extending direction of the first straight portions is different from a length in the extending direction of the second straight portions.

4. The termination circuit according to claim 1,
wherein a number of the plurality of first straight portions of the first open stub is different from a number of the plurality of second straight portions of the second open stub.

5. The termination circuit according to claim 1,
wherein, among the plurality of first straight portions, one of the first straight portions positioned in an outermost portion in an array direction is overlapped with the second connection portions of the second open stub, and
wherein, among the plurality of first straight portions, another one of the first straight portions positioned in a central portion in the array direction is orthogonal to the second straight portions of the second open stub.

6. The termination circuit according to claim 2,
wherein a length in the extending direction of the first straight portions is different from a length in the extending direction of the second straight portions.

7. The termination circuit according to claim 2,
wherein, among the plurality of first straight portions, one of the first straight portions positioned in an outermost portion in an array direction is overlapped with the second connection portions of the second open stub, and
wherein, among the plurality of first straight portions, another one of the first straight portions positioned in a central portion in the array direction is orthogonal to the second straight portions of the second open stub.

8. The termination circuit according to claim 3,
wherein, among the plurality of first straight portions, one of the first straight portions positioned in an outermost portion in an array direction is overlapped with the second connection portions of the second open stub, and
wherein, among the plurality of first straight portions, another one of the first straight portions positioned in a central portion in the array direction is orthogonal to the second straight portions of the second open stub.

9. The termination circuit according to claim 4,
wherein, among the plurality of first straight portions, one of the first straight portions positioned in an outermost portion in an array direction is overlapped with the second connection portions of the second open stub, and
wherein, among the plurality of first straight portions, another one of the first straight portions positioned in a central portion in the array direction is orthogonal to the second straight portions of the second open stub.
